(19) United States
(12) Patent Application Publication
(10) Pub. No.: US 2026/0025681 A1
(43) Pub. Date: Jan. 22, 2026

(54) INFORMATION INDICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Jinyu ZHANG, Dongguan (CN); Rongyi HU, Dongguan (CN)

(21) Appl. No.: 19/339,512

(22) Filed: Sep. 25, 2025

Related U.S. Application Data
(63) Continuation of application No. PCT/CN2023/094039, filed on May 12, 2023.

(51) Int. Cl. H04W 24/08

(52) U.S. Cl. CPC H04W 24/08

(57) ABSTRACT

The present disclosure relates to a terminal device. The terminal device includes: a processor and a memory, where the memory is configured to store a computer program, and the processor is configured to call the computer program stored in the memory and run the computer program, to cause the terminal device to perform: transmitting first indication information to a network device; where the first indication information is used to indicate gap-related information in respective cell states of multiple cell states, where a gap includes a measurement gap (MG) and/or a network controlled small gap (NCSG).

### CROSS-REFERENCE TO RELATED APPLICATION

This application is a Continuation Application of International Application No. PCT/CN2023/094039 filed on May 12, 2023, which is incorporated herein by reference in its entirety.

### TECHNICAL FIELD

The present disclosure relates to the field of communication, and more specifically, to an information indication method, a terminal device, a network device, a chip, a non-transitory computer-readable storage medium, a computer program product, a computer program, and a communication system.

### BACKGROUND

In a wireless mobile communication system, measurements of cell quality and beam quality are bases for effectively implementing radio resource management and mobility management. A terminal device may perform a measurement in a measurement gap (MG). However the MG will cause an interruption of data transmission time. To reduce the interruption interval caused by the measurement, a network controlled small gap (NSCG) is introduced into the communication system. When using the NCSG, the terminal device may perform the measurement using idle radio frequency link resources, which will not cause a longer interruption interval during the measurement procedure and maintain the measurement and serving cell data transmitting and receiving, but before and after the measurement, a shorter interruption interval will be caused by adjusting radio frequency link.

However, with the introduction of the NCSG, relevant measurement configuration methods are still not flexible enough, and there is still room for further reduction in the data transmission interruption time of data transmission caused by the measurement. It is necessary to consider how to improve the flexibility of measurement configuration.

### SUMMARY

Embodiments of the present disclosure provide an information indication method, which includes: transmitting, by a terminal device, first indication information to a network device; where the first indication information is used to indicate gap-related information in respective cell states of multiple cell states, where a gap includes an MG and/or an NCSG.

Embodiments of the present disclosure provide an information indication method, which includes: transmitting, by a network device, sixth indication information to a terminal device, where the sixth indication information is used to indicate gap-related information in respective cell states of multiple cell states, where a gap includes an MG and/or an NCSG.

Embodiments of the present disclosure provide a terminal device, which includes: a first communication module, configured to transmit first indication information to a network device; where the first indication information is used to indicate gap-related information in respective cell states of multiple cell states, where a gap includes a measurement gap (MG) and/or a network-controlled small gap (NCSG).

Embodiments of the present disclosure provide a network device, which includes: a second communication module, configured to transmit sixth indication information to a terminal device, where the sixth indication information is used to indicate gap-related information in respective cell states of multiple cell states, where a gap includes an MG and/or an NCSG.

Embodiments of the present disclosure provide a terminal device, which includes a processor and a memory. The memory is configured to store a computer program, and the processor is configured to call the computer program stored in the memory and run the computer program, to cause the terminal device to perform the above-mentioned information indication method.

Embodiments of the present disclosure provide a network device, which includes a processor and a memory. The memory is configured to store a computer program, and the processor is configured to call the computer program stored in the memory and run the computer program, to cause the network device to perform the above-mentioned information indication method.

Embodiments of the present disclosure provide a chip for implementing the above-mentioned information indication method.

Exemplarily, the chip includes: a processor configured to call a computer program from a memory and run the computer program, to cause a device equipped with the chip to perform the above-mentioned information indication method.

Embodiments of the present disclosure provide a non-transitory computer-readable storage medium, storing a computer program that, when executed by a device, causes the device to perform the above-mentioned information indication method.

Embodiments of the present disclosure provide a computer program product, including computer program instructions that cause a computer to perform the above-mentioned information indication method.

Embodiments of the present disclosure provide a computer program, when run on a computer, causing the computer to perform the above-mentioned information indication method.

### BRIEF DESCRIPTION OF THE DRAWINGS

FIG. 1 is a schematic diagram of a communication system according to embodiments of the present disclosure.

FIG. 2 is a schematic diagram illustrating measurement performed in an NCSG in embodiments of the present disclosure.

FIG. 3 is a schematic flowchart of an information indication method according to an embodiment of the present disclosure.

FIG. 4 is a schematic flowchart of an information indication method according to another embodiment of the present disclosure.

FIG. 5 is a schematic block diagram of a terminal device according to an embodiment of the present disclosure.

FIG. 6 is a schematic block diagram of a terminal device according to another embodiment of the present disclosure.

FIG. 7 is a schematic block diagram of a terminal device according to yet another embodiment of the present disclosure.

FIG. 8 is a schematic block diagram of a network device according to an embodiment of the present disclosure.

FIG. 9 is a schematic block diagram of a communication device according to an embodiment of the present disclosure.

FIG. 10 is a schematic block diagram of a chip according to an embodiment of the present disclosure.

FIG. 11 is a schematic block diagram of a communication system according to an embodiment of the present disclosure.

### DETAILED DESCRIPTION

Technical solutions in the embodiments of the present disclosure will be described below in conjunction with the drawings in the embodiments of the present disclosure.

The technical solutions in the embodiments of the present disclosure may be applied to various communication systems, such as, a global system of mobile communication (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunication system (UMTS), wireless local area networks (WLAN), wireless fidelity (WiFi), and a fifth-generation communication (5th-Generation, 5G) system or other communication systems.

Generally, a number of connections supported by a conventional communication system is limited and is easy to be implemented. However, with the development of the communication technology, a mobile communication system will not only support traditional communication, but also will support direct communication from a terminal to another terminal, such as, device to device (D2D) communication, machine to machine (M2M) communication, machine type communication (MTC), vehicle to vehicle (V2V) communication, or vehicle to everything (V2X) communication. The embodiments of the present disclosure may further be applicable to these communication systems.

In an implementation, the communication systems in the embodiments of the present disclosure may be applicable to a carrier aggregation (CA) scenario, a dual connectivity (DC) scenario, or a standalone (SA) networking scenario.

In an implementation, the communication system in the embodiments of the present disclosure may be applicable to an unlicensed spectrum, where the unlicensed spectrum may also be considered as a shared spectrum, or the communication system in the embodiments of the present disclosure may also be applied to a licensed spectrum, where the authorized spectrum may also be considered as an unshared spectrum.

Various embodiments are described in the present disclosure in combination with a network device and a terminal device. The terminal device may also be referred to as a user equipment (UE), an access terminal, a user unit, a user station, a mobile station, a mobile site, a remote station, a remote terminal, a mobile device, a user terminal, a terminal, a wireless communication device, a user agent, a user apparatus, etc.

The terminal device may be a station (STA) in WLAN, a cellular phone, a cordless phone, a session initiation protocol (SIP) phone, a wireless local loop (WLL) station, a personal digital assistant (PDA) device, a handheld device with a wireless communication function, a computing device or other processing device connected to a wireless modem, an in-vehicle device, a wearable device, a terminal device in a next-generation communication system (e.g., an NR network), or a terminal device in a future evolved public land mobile network (PLMN), etc.

In the embodiments of the present disclosure, the terminal device may be deployed on land, including indoors or outdoors, in a handheld form, in a wearable, or in an in-vehicle form. Alternatively, the terminal device may also be deployed on water (e.g., ships) or under water (e.g., submarines). Alternatively, the terminal device may also be deployed in the air (such as airplanes, balloons and satellites).

In the embodiments of the present disclosure, the terminal device may be a mobile phone, a tablet computer (Pad), a computer having a wireless transceiver function, a virtual reality (VR) terminal device, an augmented reality (AR) terminal device, a terminal device in a personal internet of things (PIT), a wireless terminal device in industrial control, a wireless terminal device in self driving, a wireless terminal device in remote medical, a wireless terminal device in a smart grid, a wireless terminal device in transportation safety, a wireless terminal device in a smart city, or a wireless terminal device in a smart home, etc.

As an example but not limitation, in the embodiments of the present disclosure, the terminal device may also be a wearable device. The wearable device, which may also be called a wearable intelligent devices, is a general term of devices that are developed by applying an intelligent design to daily wear items (such as, glasses, gloves, watches, clothes and shoes), using wearable technology that may be worn. The wearable device is a portable device that is worn directly on the body or is integrated into clothing or an accessory of a consumer. The wearable device is not only a hardware device, but also realize powerful functions through software support, data interaction and cloud interaction. In a broad sense, the wearable intelligent device includes features with comprehensive functions, large size, and achieving complete or some functions without relying on smart phone (such as smart watches or smart glasses), and the wearable intelligent device may include devices that only focus on a certain type of application function and need to be used in conjunction with any other devices (e.g., smartphone), such as various smart bracelets and smart jewelry for vital sign monitoring.

In the embodiments of the present disclosure, the network device may be a device for communicating with a mobile device. The network device may be an access point (AP) in WLAN, a base station (Base Transceiver Station, BTS) in GSM or CDMA, a base station (NodeB, NB) in WCDMA, an evolved base station (Evolutional Node B, eNB or eNodeB) in LTE, a relay station or access point, an in-vehicle device, a wearable device, a network device (gNB) in the NR network, a network device in a future evolved PLMN, or a network device in NTN, etc.

As an example but not limitation, in the embodiments of the present disclosure, the network device may have a mobile characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. Optionally, the network device may also be a base station deployed on land, water, or other locations.

In an embodiments of the present disclosure, the network device may provide services for a cell, and a terminal device may communicate with the network device through transmission resources (e.g., frequency domain resources, or spectrum resources) used by the cell. The cell may be a cell corresponding to a network device (e.g., base station). The cell may belong to a macro base station, or belong to a base station corresponding to a small cell. The small cell here may include a metro cell, a micro cell, a pico cell, a femto cell, etc. The small cell has characteristics of a small coverage and a low transmission power, and is suitable for providing a high-speed data transmission service.

FIG. 1 exemplary illustrates a communication system 100. The communication system includes a network device 110 and two terminal devices 120. In a possible implementation, the communication system 100 may include multiple network devices 110, and there are other quantities of terminal devices 120 within a coverage area of each network device 110, which is not limited in the embodiments of the present disclosure.

In a possible implementation, the communication system 100 may further include other network entities, such as a mobility management entity (MME) and an access and mobility management function (AMF), which are not limited in the embodiments of the present disclosure.

The network device may further include an access network device and a core network device. That is, the wireless communication system further includes multiple core networks for communicating with the access network device. The access network device may be a base station in a long-term evolution (LTE) system, next-generation (mobile communication system) (next radio, NR) system or authorized auxiliary access long-term evolution (LAA-LTE) system, such as an evolved base station (evolutional node B, which may be abbreviated as eNB or e-NodeB), a macro base station, a micro base station (also called small base station), a pico base station, an access point (AP), a transmission point (TP) or a new generation Node B (gNodeB).

It should be understood that, in the embodiments of the present disclosure, the device having a communication function in a network/system may be referred to as a communication device. Taking the communication system illustrated in FIG. 1 as an example, the communication device may include the network device and terminal device with the communication function. The network device and terminal device may be specific devices in the embodiments of the present disclosure, which will not be repeated here. The communication device may further include other devices in the communication system, such as a network controller, a mobile management entity and other network entities, which are not limited in the embodiments of the present disclosure.

To facilitate understanding of the embodiments of the present disclosure, basic processes and basic concepts involved in the embodiments of the present disclosure are briefly described below. It should be understood that the basic processes and basic concepts introduced below do not limit the embodiments of the present disclosure.

It should be understood that the terms “system” and “network” are often used interchangeably herein. The term “and/or” herein is only an association relationship to describe associated objects, indicating that there may be three kinds of relationships between associated objects, for example, A and/or B may represent three cases: A exists alone, both A and B exist, and B exists alone. In addition, a character “/” herein generally indicates that associated objects before and after this character are in an “or” relationship.

It should be understood that, the “indication” and other variations thereof mentioned in the embodiments of the present disclosure may mean a direct indication or an indirect indication, or may represent that there is an associated relationship. For example, A indicates B, which may mean that A directly indicates B, for example, B may be obtained via A, or may mean that A indirectly indicates B, for example, A indicates C, and B may be obtained via C, or may mean that there is an association relationship between A and B.

In the description of the embodiments of the present disclosure, the term “correspondence” and other variations thereof may mean that there is a direct correspondence or indirect correspondence between the two, or may mean that there is an association relationship between the two, or may mean a relationship of indicating and being indicated, configuring and being configured, or the like.

To facilitate understanding of the technical solutions in the embodiments of the present disclosure, relevant technologies of the embodiments of the present disclosure are described below, the following related technologies may be arbitrarily combined with the technical solutions in the embodiments of the present disclosure as optional solutions, which are the protection scope of the embodiments of the present disclosure.

Compared with an MG, an NCSG may reduce the interruption time required for measurement. FIG. 2 is a schematic diagram illustrating measurement performed in an NCSG in the embodiments of the present disclosure. In FIG. 2, the measurement of synchronization signal block (SSB) is taken as an example for illustration, the UE may use idle radio frequency link (RF chain) resources (e.g., RF chain 2 in FIG. 2) to perform the measurement. During the measurement length (ML), the UE may simultaneously maintain the measurement of neighboring cells and the serving cell data transmitting and receiving, without causing a long interruption time, but only a shorter interruption will be caused within the time of the visible interruption length (VIL) before and after the measurement. As illustrated in FIG. 2, there are certain differences between the NCSG pattern and an ordinary MG pattern, the NCSG pattern, as defined in the related art, includes a repetition period (visible interruption repetition period, VIRP) and an ML.

For SSB based measurement objects, the user (i.e., terminal device) may dynamically report whether the corresponding measurement requires an MG or NCSG through the signaling needForGapNCSG-reporting-r17={gap, ncsg, nogap-noncsg}, where the option “gap” indicates that the MG is required, the option “ncsg” indicates that the NCSG is required, and the option “nogap-noncsg” indicates that the MG and NCSG are not required. The network will configure the appropriate MG or NCSG based on the information reported by the user, to make the user to complete the measurement. Details are as follows.

When needForGapNCSG is set to nogap-noncsg, it means that the user may measure the measurement object of the frequency point outside the MG and NCSG. The network may configure the user to perform the measurement in the MG and NCSG, or configure the user to perform the measurement outside the MG and NCSG.

When needForGapNCSG is set to nesg, it means that the user needs to measure the measurement object of the frequency point in the NCSG. The network may configure the user to perform the measurement in the MG or NCSG.

When needForGapNCSG is set to gap, it means that the user needs to measure the measurement object of the frequency point in the MG. The network may only configure the user to perform the measurement in the MG.

A typical application scenario of the NCSG is to perform measurement on a deactivated secondary cell (deactivated SCell) or a dormant secondary cell (dormant SCell). Generally, in a scenario of carrier aggregation (CA), a RF link is configured for the SCell of each carrier component (CC). When the SCell is deactivated or in a dormant state, the corresponding RF link will be also closed. If the measurement needs to be performed on the deactivated SCell, the corresponding RF link resources may be used to receive the reference signals, without occupying RF links of other serving cells. In this case, only a brief interruption for transmitting and receiving data of other serving cells will be caused at the VIL due to the turning on or off of the RF link, while in ML, the measurement of the deactivated SCell and transmitting and receiving data of other serving cells may be performed simultaneously perform.

Currently, the measurement of the deactivated SCell or dormant Scell may use the NCSG by default without determining based on the information reported by the user.

Furthermore, in the related art, the combination of the NCSG and concurrent gaps is considered, that is, multiple gaps (GAPs) may be configured for the user, and at least one of the GAPs is the NCSG. The configuration of the GAP (including the GAP pattern and the association between the GAP and an MO) is completed via radio resource control (RRC) information. The SCell being activated may be achieved via a media access control control element (MAC Control Element, MAC CE) or other methods. If the state of SCell changes, whether the measurement of the SCell requires the MG/NCSG will also changes accordingly. In this case, the associated measurement GAP also needs to be updated, but there will be long delay if the reconfiguration is performed via an RRC message.

It can be seen that, currently, the measurement configuration is still not flexible enough, resulting in situations where terminal capabilities cannot be fully utilized to reduce data interruption time, For example, there are the following two situations.

1. The measurements for the deactivated SCell are divided into two types: without GAP and with NCSG. When the SCell is in the deactivated state, the NCSG may be used for measurement by default, however, the information reported by the user via the needForGapNCSG is for the activated state of the SCell, which will make the type of without gap cannot be used for the deactivated SCell, that is, the measurement must be performed at least in the NCSG.

2. In a case where concurrent GAPs are supported, the network may configure multiple GAPs for the user. GAP requirements of the SCell in the activated state and deactivated state are different, for example, the NCSG is sufficient in the deactivated state or the dormant state, while the MG may be required in the activated state. If the same GAP is configured for different states of the SCell, the NCSG may not be fully utilized to reduce the data transmission interruption time of data transmission. Meanwhile, SCell being activated/deactivated may be achieved via a MAC CE, and dormant bandwidth part (BWP) switching (which can make the SCell to sleep/wake up) may be achieved via a DCI mechanism or a timer mechanism. However, the GAP configuration needs to be implemented via RRC signaling, and there will be long delay when switching GAP configuration.

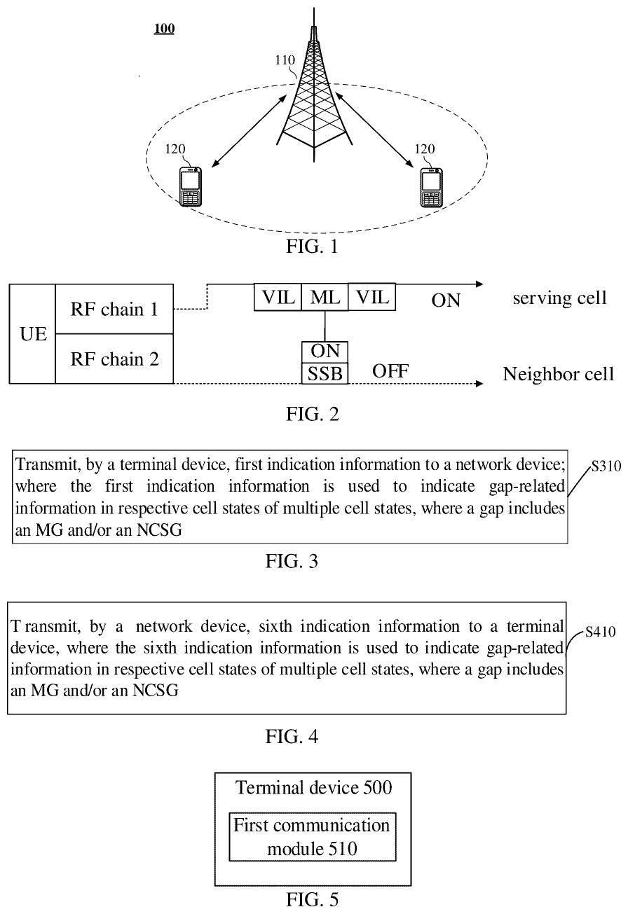

The technical solutions in the embodiments of the present disclosure are mainly to solve at least one of the above-mentioned technical problems. FIG. 3 is a schematic flowchart of an information indication method according to an embodiment of the present disclosure. The method may optionally be applied to the system illustrated in FIG. 1, but is not limited thereto. The method includes at least portion of the following.

S310, transmitting, by a terminal device, first indication information to a network device; where the first indication information is used to indicate gap-related information in respective cell states of multiple cell states, where a gap includes an MG and/or an NCSG.

Exemplarily, the first indication information may be used to indicate information such as capabilities or requirements related to the gap of the terminal device in different cell states. In this way, the network device may reasonably configure the GAP for the terminal device according to the capabilities or requirements of the terminal device in different cell states, so as to fully utilize the terminal capabilities, and reduce the interruption time of data transmission and reception.

Optionally, the first indication information is used to indicate gap requirements for measuring a first MO by the terminal device in the respective cell states. The gap requirement may refer to whether the terminal device needs an MG to measure the first MO, and/or the terminal device needs an NCSG to measure the first MO. It should be noted that the first indication information may be indication information for a single MO (i.e., indication for the first MO), or may be indication information for a category of MOs (the category of MOs includes the first MO).

It should be noted that, in the embodiments of the present disclosure, the MO may also be called a frequency point to be measured, or in other words, the MO corresponds to the frequency point to be measured, and the indication for the MO may also be regarded as the indication for the frequency point to be measured.

Optionally, a gap requirement may be one of the following: the MG being required, the NCSG being required, the GAP being not required. For example, the first indication information may indicate one option among {gap, ncsg, nogap-noncsg}, where gap indicates that the MG is required, the ncsg indicates that the NCSG is required, and nogap-noncsg indicates that the GAP is not required.

Optionally, the multiple cell states may include a cell state of a secondary cell (SCell).

Optionally, the cell state of the SCell is determined based on whether the SCell is activated and/or whether the SCell is dormant.

Exemplarily, the multiple cell states include a first state of the SCell and a second state of the SCell.

For example, the first state may be an SCell activated state, and the second state may be an SCell deactivated state. Further, the first state may include an activated and non-dormant state or an activated and dormant state.

For another example, the first state may be an SCell non-dormant state, and the second state may be an SCell dormant state.

For yet another example, the first state may be an SCell activated and non-dormant state, and the second state may be an SCell deactivated state or the SCell dormant state (activated and dormant state).

It may be understood that the multiple cell states may also include three or more states, for example, the first state may be the SCell activated and non-dormant state, the second state may be the SCell activated and dormant state, and the third state may be the SCell deactivated state. The specific details may be determined based on actual requirements, a protocol, or a system agreement.

It should be noted that, in practical application, in order to identify different cell states, the cell states may be numbered. The numbers of the cell states may be preset according to a protocol or a system agreement. The “first” and “second” in the first state and second state are only used to distinguish different cell states, and do not completely correspond to the numbers of the cell states in practical applications. For example, the first state may refer to state 1 in the practical application, and the second state may indicate state 2 in the practical application; or, the first state may refer to state 2 in the practical application, and the second state may indicate state 1 in the practical application.

It should be noted that, in different cell states, the gap requirement may have different options. Exemplarily, the gap requirement indicated by the terminal device in the first state may be that the MG is required, the NCSG is required, or the GAP is not required, and the gap requirement in the second state may be that the NCSG is required, or the GAP is not required.

Optionally, there are multiple implementations of the first indication information, and three exemplary implementations are provided below.

Manner 1: the first indication information includes multiple gap requirement indications of the first MO, and the multiple gap requirement indications correspond one-to-one with the multiple cell states; where each gap requirement indication of the multiple gap requirement indications is used to indicate a gap requirement for measuring the first MO in a corresponding cell state.

Exemplarily, the multiple gap indications (gap requirement indications) include a gap indication (gap requirement indication) of the first state and a gap indication of the second state. The gap indication of the first state is used to indicate that, in the first state, an MG is required, an NCSG is required, or a GAP is not required for measuring the first MO. The indication of the second state is used to indicate that, in the second state, an MG is required, an NCSG is required, or a GAP is not required for measuring the first MO, or is used to indicate that, in the second state, an NCSG is required, or a GAP is not required for measuring the first MO. The first state may be the SCell activated state or the SCell non-dormant state set according to a protocol, and the second state may be the SCell deactivated state or the SCell dormant state set according to the protocol.

For example, the first indication information may be a signaling NeedForGapNCSG from the terminal device dynamically reporting whether the MG/NCSG is needed. In the related art, for each frequency point/MO, a gap indication (gapIndication) is included in the signaling NeedForGapNCSG. In the embodiments of the present disclosure, the gap indication may be used as the gap indication of the first state, and at least one gap indication may be added as the gap indication of at least one other state. For example, refer to the following information to set the signaling NeedForGapNCSG:

| | |
|---|---|
| NeedForGapNCSG-InfoNR-r17 ::= | SEQUENCE { |
| intraFreq-needForNCSG-r17 | NeedForNCSG-IntraFreqList-r17, |
| interFreq-needForNCSG-r17 | NeedForNCSG-BandListNR-r17 |

```
  }
  NeedForNCSG-IntraFreqList-r17 ::= SEQUENCE (SIZE (1.. maxNrofServingCells)) OF
NeedForNCSG-IntraFreq-r17
```

| | |
|---|---|
| NeedForNCSG-IntraFreq-r17 ::= | SEQUENCE { |
| servCellId-r17 | ServCellIndex, |
| gapIndicationIntra-r17 | ENUMERATED {gap, ncsg, nogap-noncsg} |
| gapIndicationIntra-deactivatedSCell-r18 | ENUMERATED {gap, ncsg, nogap-noncsg} |

Here, gapIndicationIntra-r17 is the gap indication of the first state, and gapIndicationIntra-deactivatedSCell-r18 is the gap indication of the second state. Optionally, the value option of the gap indication of the second state may further be {ncsg, nogap-noncsg}, that is:
gapIndicationIntra-deactivatedSCell-r18 ENUMERATED {ncsg, nogap-noncsg}

Manner 2: the first indication information includes a gap requirement sequence of the first MO, and the gap requirement sequence includes gap requirements corresponding to the respective cell states.

That is, a sequence may be added to the relevant signaling, where multiple elements in the sequence are multiple gap requirements, and positions of the elements correspond to the cell states, for example, the gap requirements of the respective cell states is sorted in the order of the number of the respective cell states. For example, the first element in the sequence is the gap requirement corresponding to the state 1, and the second element in the sequence is the gap requirement corresponding to the state 2, where the state 1 and the state 2 are determined according to the protocol or the system agreement. As an example but not limitation, the state 1 may be the first state mentioned above, such as the SCell activated state or the SCell non-dormant state; the state 2 may be the second state mentioned above, such as the SCell deactivated state or the SCell dormant state.

For example, adding a sequence gapIndicationIntra-SCell-r18 to the signaling NeedForGapNCSG may be:

| | |
|---|---|
| NeedForGapNCSG-InfoNR-r17 ::= | SEQUENCE { |
| intraFreq-needForNCSG-r17 | NeedForNCSG-IntraFreqList-r17, |
| interFreq-needForNCSG-r17 | NeedForNCSG-BandListNR-r17 |

```
  }
  NeedForNCSG-IntraFreqList-r17 ::= SEQUENCE (SIZE (1.. maxNrofServingCells))
OF NeedForNCSG-IntraFreq-r17
```

| | |
|---|---|
| NeedForNCSG-IntraFreq-r17 ::= | SEQUENCE { |
| servCellId-r17 | ServCellIndex, |
| gapIndicationIntra-r17 | ENUMERATED {gap, ncsg, nogap-noncsg} |
| gapIndicationIntra-SCell-r18 | SEQUENCE {gapIndication1, |

gapIndication2}

Here, gapIndicationIntra-r17 is the original gap indication, which may be used for the case that the MO only indicates a single gap requirement. The newly added gapIndicationIntra-SCell-r18 is a sequence in which the element gapIndication1 is the gap requirement of the first state, which may be one of the MG being required, the NCSG being required, and the GAP being not required; the element gapIndication2 is the gap requirement of the second state, which may be one of the MG being required, the NCSG being required, and the GAP being not required, or may be one of the NCSG being required and the GAP being not required. In a case where NeedForGapNCSG includes gapIndicationIntra-SCell-r18, the UE may choose not to report gapIndicationIntra-r17; alternatively, the UE may report gapIndicationIntra-r17, but the newly added gapIndicationIntra-SCell-r18 may cover the original gapIndicationIntra-r17.

Manner 3: the first indication information includes a target MO related indication, the target MO related indication is used to indicate gap requirements for measuring respective MOs in a target MO set in the respective cell states, and the target MO set includes the first MO.

That is to say, the first indication information is an indication for the target MO set, or an indication for a category of MOs.

Exemplarily, the target MO set may be configured by the network device via other signaling. For example, respective MOs in the target MO set may be MOs in an MO sequence indicated by the network device via second indication information.

Alternatively, the target MO set may also be determined based on a predefined condition. For example, respective MOs in the target MO set may be MOs related to a secondary cell, and the terminal device and the network device may determine whether each MO is related to the secondary cell according to the configuration of each MO and the configuration of the cell.

Optionally, the gap requirements of different cell states in the target MO related indication may also be set with reference to Manner 1 or Manner 2.

Exemplarily, the target MO related indication may include multiple gap requirement indications, and the multiple gap requirement indications correspond one-to-one with the multiple cell states; where each gap requirement indication of the multiple gap requirement indications is used to indicate gap requirements for measuring respective MOs in the target MO set in a corresponding cell state.

For example, the signaling NeedForGapNCSG contains the following indication:

| | |
|---|---|
| NeedForGapNCSG-InfoNR-r17 ::= | SEQUENCE { |
| intraFreq-needForNCSG-r17 | NeedForNCSG-IntraFreqList-r17, |
| interFreq-needForNCSG-r17 | NeedForNCSG-BandListNR-r17, |
| multiState-needForNCSG | NeedForNCSG-FreqList-r18 |

}

| | |
|---|---|
| NeedForNCSG-FreqList-r18 | ::= SEQUENCE (SIZE (1.. maxNrofServingCells)) OF |

NeedForNCSG-SCell-r18

| | |
|---|---|
| NeedForNCSG-SCell-r18 ::= | SEQUENCE { |
| servCellId-r17 | ServCellIndex, |
| gapIndicationIntra-r17 | ENUMERATED {gap, ncsg, nogap-noncsg} |
| gapIndicationIntra-deactivatedSCell-r18 | ENUMERATED {gap, ncsg, nogap-noncsg} |

Here, the newly added multiState-needForNCSG is the target MO related indication, in which the gap indication gapIndicationIntra-r17 included indicates the gap requirement of the first state, and the gap indication gapIndicationIntra-deactivatedSCell-r18 indicates the gap requirement of the second state. In the case where the target MO set is a set of MOs related to the secondary cell, the target MO related indication may also be named SCell-needForNCSG-r18.

Exemplarily, the target MO related indication includes a gap requirement sequence of the target MO set, and the gap requirement sequence includes gap requirements corresponding to the respective cell states.

For example, the signaling NeedForGapNCSG contains the following indication:

| | |
|---|---|
| NeedForGapNCSG-InfoNR-r17 ::= | SEQUENCE { |
| intraFreq-needForNCSG-r17 | NeedForNCSG-IntraFreqList-r17, |
| interFreq-needForNCSG-r17 | NeedForNCSG-BandListNR-r17, |
| multiState-needForNCSG-r18 | NeedForNCSG-FreqList-multiState-r18 |

```
  }
  NeedForNCSG-FreqList-multiState-r18 ::= SEQUENCE (SIZE (1.. maxNrofServingCells))
OF NeedForNCSG-multiState-r18
```

| | |
|---|---|
| NeedForNCSG-multiState-r18 ::= | SEQUENCE { |
| servCellId-r17 | ServCellIndex, |
| gapIndicationIntra-multiState-r18 | SEQUENCE {gapIndication1, gapIndication2} - |

Optional;

Here, the newly added multiState-needForNCSG-r18 is the target MO related indication, in which the gap requirement sequence gapIndicationIntra-SCell-r18 contained includes gap requirements of two cell states.

In some embodiments, the terminal device transmitting the first indication information, which may be reported based on the request from the network device. Exemplarily, transmitting, by the terminal device, the first indication information to the network device may include: in a case where second indication information from the network device is received, transmitting, by the terminal device, the first indication information to the network device. The second indication information is used to instruct the terminal to report gap requirements corresponding to the respective cell states of the multiple cell states.

It should be noted that, in the embodiment of the present disclosure, the instruction information transmitted by the network device to the terminal device may also be called configuration information.

Optionally, there are multiple implementations of the second indication information, and two exemplary implementations are provided below.

Manner 1: the second indication information includes an MO sequence, and the second indication information is used to instruct the terminal device to report gap requirements for measuring respective MOs in the MO sequence in the respective cell states, and the MO sequence includes the first MO.

The MO sequence may also be called a frequency point sequence, which includes multiple frequency points to be measured.

Exemplarily, the second indication information may be carried by an RRC configuration message. That is, a signaling may be added to the RRC configuration message, and the signaling is an MO sequence. When the RRC configuration message received by the terminal device includes the MO sequence, the terminal device may determine that the network device requests to report gap requirements for measuring respective MOs in the MO sequence in different cell states, then, the terminal device transmits the first indication information. When the RRC configuration message received by the terminal device does not include the MO sequence, the terminal device may determine that the network device has not requested to report the gap requirements for measuring respective MOs in the MO sequence in different cell states.

Optionally, the signaling newly added to the RRC configuration message may be named NeedForGapNCSG-ConfigNR-SCell-r18 or NeedForGapNCSG-ConfigNR-multiState-r18. For example, the RRC configuration message is as follows:

| | |
|---|---|
| | needForGapNCSG-ConfigNR-r17 SetupRelease {NeedForGapNCSG-ConfigNR- |
| r17} | OPTIONAL, |
| | needForGapNCSG-ConfigNR-multiState-r18 SetupRelease {NeedForGapNCSG- |

ConfigNR-multiState-r18} OPTIONAL

It can be seen that the RRC configuration message may include needForGapNCSG-ConfigNR-r17 and needForGapNCSG-ConfigNR-SCell-r18. Where needForGapNCSG-ConfigNR-r17 is used to request other MOs/frequency points to report a gap requirement for measuring. The gap requirement is for all cell states, that is, there is no gap requirement reported separately for each cell state. needForGapNCSG-ConfigNR-multiState-r18 is the MO sequence/frequency point sequence.

The structure of needForGapNCSG-ConfigNR-multiState-r18 is as follows:

| | |
|---|---|
| NeedForGapNCSG-ConfigNR-multiState-r18 ::= | SEQUENCE { |
| requestedTargetBandFilterNCSG-NR-r17 | SEQUENCE (SIZE (1..maxBands)) OF |
| FreqBandIndicatorNR | OPTIONAL |

It can be seen that needForGapNCSG-ConfigNR-multiState-r18 is a frequency point sequence/MO sequence, for each frequency point/MO to be measured contained therein, the terminal device needs to report gap requirements for measuring in different cell states.

Manner 2: the second indication information includes first switch information, and the first switch information is used to indicate whether the terminal device is requested to report the gap requirements for measuring the first MO in the respective cell states.

Exemplarily, the second indication information is a switch, which indicates that the terminal device is requested to report the gap requirements for measuring the first MO in the respective cell states, or the terminal device does not need to report the gap requirements for measuring the first MO in the respective cell state. The terminal device may transmit the first indication information, in a case where the second indication information is received and the first switch information therein indicates that the terminal device needs to report the gap requirements for the respective cell states.

Optionally, the first MO is an MO that meets a predetermined condition. That is, the first switch information may be indicated for a category of MOs that meet a certain condition, and the category of MOs includes the first MO.

Optionally, the method may further include: determining, by the terminal device, that the first MO meets the predetermined condition according to configuration information of the first MO.

Optionally, the predetermined condition is that the first MO is related to a secondary cell.

For example, according to configuration information of respective MOs and configuration information of respective cells, the terminal device and the network device may determine cell IDs corresponding to the respective MOs. Therefore, the network device indicates, via the first switch information, that it is requested to report gap requirements for measuring for respective MOs related to the secondary cell in different cell states. Accordingly, the terminal device may determine the first MO related to the secondary cell, and report the first indication information to indicate the gap requirements for measuring the first MO in different cell states.

Optionally, the first switch information may be named NeedForGapNCSG-ConfigNR-multiState-r18, which is as follows:

Enable-NeedForGapNCSG-Config-multiState-r18 ENUMERATED
{supported} OPTIONAL

Alternatively, in a case where the predetermined condition is that the first MO is related to the secondary cell, the first switch information may also be named Enable-NeedForGapNCSG-Config-SCell-r18, which is as follows:

```
  Enable-NeedForGapNCSG-Config-SCell-r18 ENUMERATED
  {supported}
OPTIONAL
```

It can be seen that, in the above embodiments, the terminal device may transmit the first indication information based on the second indication information of the network device. In other embodiments, the terminal device may also autonomously transmit the first indication information, that is, there is no need for the network side to transmit relevant request information to the terminal device. Exemplarily, for MOs that meet the predetermined condition, the terminal device may transmit the first indication information by default. That is, the first MO is the MO that meets the predetermined condition, for example, the first MO is related to the secondary cell.

Optionally, whether the terminal device can report the gap requirements corresponding to different cells is a capability. In some embodiments of the present disclosure, the terminal device may further report the capability to the network device. Exemplarily, before the terminal device transmits the first indication information to the network device, the information indication method further includes: transmitting, by the terminal device, fifth indication information to the network device; where the fifth indication information is used to indicate that the terminal device has a second capability, the second capability includes supporting reporting gap requirements corresponding to the respective cell states.

In the practical application, the second capability may be named nr-NeedForGapNCSG-reporting-multiState-r18. In a case where the terminal device indicates that it has the capability, the network device may transmit the second indication information to the terminal device, to request the terminal device to report the gap requirements corresponding to respective cell states. Alternatively, in a case where the terminal device indicates that it has the capability, the network device may know that the terminal device will report the gap requirements corresponding to respective cell states for MOs that are meet the predetermined condition. That is, the capability reporting process may be combined with the embodiment of which the network device transmits the second indication information, or may be implemented decoupled from the embodiment.

Through the above embodiments, the terminal device may indicate the gap requirements in different cell states to the network device, so that the network device may perform measurement configuration for the terminal device according to the indication of the terminal device. For example, in a case where the terminal device indicates that the gap is not required in the first state and the second state, the network device may consider not configuring an associated gap for the MO, and the terminal device performs the measurement outside the gap. In this way, the problem that there is no out-of-gap measurement in the deactivated Scell in the related art may be overcome, so that the terminal device may measure the deactivated Scell outside the gap. It can be seen that, according to the embodiments of the present disclosure, flexible indication of the terminal capability/requirement is achieved, which is conducive to fully utilizing the terminal capability and may reduce the interruption time of data transmission and reception in some scenarios.

According to some embodiments of the present disclosure, the network device may further make different configurations for the terminal device according to different cell states.

Exemplarily, in some embodiments, the information indication method may further include:
receiving, by the terminal device, third indication information from the network device; where the third indication information is used to indicate multiple gaps associated with a first MO, and the multiple gaps include gaps corresponding to the respective cell states of the multiple cell states.

Optionally, the third indication information may be carried by configuration information of the first MO. That is, when the network device configures the first MO, it will configure the gaps of the first MO in different cell states, and the gap may be the MG or the NCSG.

Optionally, the gaps corresponding to different cell states may be the same gap or may be different gaps. For example, the network configures, via the third indication information, that the terminal device uses GAP1 to measure the first MO in the first state and uses GAP2 to measure the first MO in the second state. GAP1 and GAP2 may be the same gap or different gaps. Here, the gaps being the same or different means that patterns of the gaps are the same or different.

Optionally, the gaps corresponding to different cell states may be the gaps with the same type or different types. For example, GAP1 is the MG, and GAP2 may be the MG or the NCSG.

Optionally, the information indication method may further include: when switching cell states, determining, by the terminal device, a gap used for measuring the first MO according to the third indication information.

That is, in a case where the third indication information is configured (which means that the network configures the GAPs in different cell states at once), when switching the cell states, the terminal device may directly switch to the corresponding gap for measurement according to the configuration, without the need for the network device to reconfigure the gap associated with the first MO via the RRC configuration message. In a scenario of switching SCell states, it will be achieved that the associated GAP may be changed according to the state of the SCell without long delay. In this way, the advantage of fully utilizing different gaps may be achieved through flexible configuration, which is conducive to further reducing the interruption time of data transmission and reception.

Optionally, there are multiple implementations of the third indication information, and two exemplary implementations are provided below.

Manner 1: the third indication information includes multiple associated gap indications corresponding one-to-one with the multiple cell states, and each associated gap indication of the multiple associated gap indications is used to indicate an identifier of a gap used in a corresponding cell state.

For example, in the related art, configuration information of the first MO may include an associated gap indication associatedMeasGapSSB-r17, which is used to indicate an identifier (ID) of the gap associated with the first MO. In the embodiments of the present disclosure, an associated gap indication associatedMeasGapSSB-deactivedSCell-r18 may be added. Here, the associated gap indication associatedMeasGapSSB-r17 indicates the ID of the gap adopted by the first MO in the first state, and the associated gap indication associatedMeasGapSSB-secondState-r18 indicates the ID of the gap adopted by the first MO in the second state. The details are as follows:

| | | | |
|---|---|---|---|
| associatedMeasGapSSB-r17 | MeasGapId-r17 | OPTIONAL, | -- |

Need R

| | | | |
|---|---|---|---|
| associatedMeasGapSSB-secondState-r18 | MeasGapId-r17 | OPTIONAL, | -- |

Need R

Manner 2: the third indication information includes a gap identifier sequence, and the gap identifier sequence includes identifiers of respective gaps of the multiple gaps. That is, the third indication information carries the IDs of the respective gaps via the sequence. Corresponding cell states are determined by positions of respective elements (i.e., respective gap IDs) in the sequence, for example, the first gap ID corresponds to the first state, and the second gap ID corresponds to the second state.

For example, the configuration information of the first MO includes the following information:

associatedMeasGapSSB-multiState-r18 SEQUENCE/LIST{MeasGapId1-r17,
MeasGapId2-r17} OPTIONAL, -- Need R

Here, associatedMeasGapSSB-SCell-r18 represents the gap identifier sequence.

Optionally, whether to support configuring multiple gaps for an MO may be regarded as a capability of the terminal. In some embodiments of the present disclosure, the terminal device may reports the capability to the network device.

Exemplarily, before the terminal device receives the third indication information from the network device, the information indication method may further include: transmitting, by the terminal device, fourth indication information to the network device, where the fourth indication information is used to indicate that the terminal device has a first capability, and the first capability includes supporting configuring the multiple gaps for the first MO.

Optionally, in a case where the fourth indication information is received, i.e., in a case where the terminal has the first capability, the network device may transmit the third indication information to the terminal device. Otherwise, the network device may configure the first MO for the terminal device to be associated with only one gap.

Optionally, the first capability may be associated with the second capability of supporting reporting the gap requirements corresponding to the respective cell states in the aforementioned embodiments.

Exemplarily, the terminal device needs to indicate whether it supports the second capability to the network device only when the terminal device has the first capability. Exemplarily, transmitting, by the terminal device, the fifth indication information to the network device includes: in a case where the terminal device has the first capability, transmitting, by the terminal device, the fifth indication information to the network device; where the first capability includes supporting configuring multiple gaps for the first MO. Correspondingly, the terminal device reports, based on the second capability, the gap requirements for measuring the first MO in different cell states to the network device, and then the network device configures the first MO for the terminal to be associated with the multiple gaps based on the requirement information of the terminal device and the first capability information.

Exemplarily, the first capability and the second capability are reported in the same signaling, that is, the terminal device may only report the fifth indication information, and the fifth indication information is used to indicate that the terminal device has the second capability and is further used to indicate that the terminal device supports the first capability. In a case where the terminal device does not report the fifth indication information, it indicates that the terminal device does not have the first capability and/or the second capability.

Optionally, the reporting manner of the first capability and the second capability may be the same as the reporting manner of other measurement-related capabilities of the terminal, for example, reported via nr-NeedForGapNCSG-reporting.

Optionally, the interaction manner of the first capability and the second capability on the network side may also be the same as other capabilities. For example, after switching cell, a source cell will forward the capability to a target cell.

FIG. 4 is a schematic flowchart of the information indication method according to another embodiment of the present disclosure. The method may optionally be applied to the system illustrated in FIG. 1, but is not limited thereto. The method includes at least portion of the following.

S410, transmitting, by the network device, sixth indication information to a terminal device, where the sixth indication information is used to indicate gap-related information in respective cell states of multiple cell states, where a gap includes an MG and/or an NCSG.

According to the method, the network device may indicate gap-related information in different cell states to the terminal device, realizing flexible configuration related to terminal measurements, being conducive to fully utilize terminal capabilities and characteristics of different cell states, thus further reducing the interruption time of data transmission and reception.

In some embodiments, the sixth indication information includes third indication information, and the third indication information is used to indicate multiple gaps associated with a first MO, and the multiple gaps include gaps corresponding to the respective cell states of the multiple cell states.

In a case where the third indication information is sent (which means that the network configures the GAPs in different cell states at once), when switching the cell states, the terminal device may directly switch to the corresponding gap for measurement according to the configuration, without the need for the network device to reconfigure the gap associated with the first MO via the RRC configuration message. In a scenario of switching SCell states, it will be achieved that the associated GAP may be changed according to the state of the SCell without long delay may be realized without a long delay.

Optionally, the third indication information is carried by configuration information of the first MO.

Exemplarily, the third indication information includes multiple associated gap indications corresponding one-to-one with the multiple cell states, and each associated gap indication of the multiple associated gap indications is used to indicate an identifier of a gap used in a corresponding cell state.

Exemplarily, the third indication information includes a gap identifier sequence; the gap identifier sequence includes identifiers of respective gaps of the multiple gaps.

The setting manner of the third indication information may refer to the corresponding description in the aforementioned embodiments, which will not be repeated here.

Optionally, in a case where the terminal device has a first capability, the network device may transmit the third indication information to the terminal device. Exemplarily, the information indication method may further include: receiving, by the network device, fourth indication information from the terminal device, where the fourth indication information is used to indicate that the terminal device has the first capability, and the first capability includes supporting configuring the multiple gaps for the first MO.

It should be noted that, the scheme of which the network device transmits the third indication information in the above embodiment may be independent of the scheme of which the terminal device transmits the first indication information in the aforementioned embodiments. For example, the terminal device does not need to transmit the first indication information to the network device, and the network device may determine that the NCSG can be used (that is, NCSG is required but MG is not required) by default in a case where the SCell is deactivated, and the gap requirement in the SCell activated state may be determined by a single gap indication reported by the terminal, e.g., gapIndicationIntra-r17. In this way, although the terminal device does not report the gap requirements corresponding to different cell states, the network device may still determine the gap requirements corresponding to different cell states, thereby configuring the associated GAPs for different cell states respectively.

Optionally, the scheme of which the network device transmits the third indication information may be combined with the scheme of which the terminal device transmits the first indication information in the aforementioned embodiments. Exemplarily, the information indication method may further include: receiving, by the network device, first indication information from the terminal device; where the first indication information is used to indicate gap requirements for measuring a first MO by the terminal device in the respective cell states.

Optionally, a gap requirement is one of the following: the MG being required, the NCSG being required, and the measurement gap being not required.

Optionally, the first indication information includes multiple gap requirement indications of the first MO, and the multiple gap requirement indications correspond one-to-one with the multiple cell states; where each gap requirement indication of the multiple gap requirement indications is used to indicate a gap requirement for measuring the first MO in a corresponding cell state.

Optionally, the first indication information includes a gap requirement sequence of the first MO, and the gap requirement sequence includes gap requirements corresponding to the respective cell states.

Optionally, the first indication information includes a target MO related indication, the target MO related indication is used to indicate gap requirements for measuring respective MOs in a target MO set in the respective cell states, and the target MO set includes the first MO.

Optionally, the target MO related indication includes multiple gap requirement indications of the target MO set, and the multiple gap requirement indications correspond one-to-one with the multiple cell states; where each gap requirement indication of the multiple gap requirement indications is used to indicate gap requirements for measuring respective MOs in the target MO set in a corresponding cell state.

Optionally, the target MO related indication includes a gap requirement sequence of the target MO set, and the gap requirement sequence includes gap requirements corresponding to the respective cell states.

Optionally, the multiple cell states include a cell state of a secondary cell.

Optionally, the cell state of the secondary cell is determined based on whether the secondary cell is activated and/or whether the secondary cell is dormant.

The setting manner of the first indication information may refer to the corresponding description in the aforementioned embodiments, which will not be repeated here.

Optionally, the method may further include: receiving, by the network device, fifth indication information from the terminal device, where the fifth indication information is used to indicate that the terminal device has a second capability, where the second capability includes supporting reporting gap requirements corresponding to the respective cell states.

Optionally, receiving, by the network device, the fifth indication information from the terminal device, includes:
in a case where the fourth indication information from the terminal device is received, receiving, by the network device, the fifth indication information from the terminal device, where the fourth indication information is used to indicate that the terminal device has a first capability, and the first capability includes supporting configuring the multiple gaps for the first MO.

Optionally, the fifth indication information is further used to indicate that the terminal device has a first capability, where the first capability includes supporting configuring the multiple gaps for the first MO.

The technical details regarding the reporting of the terminal capability may be referred to the corresponding description in the aforementioned embodiments, which will not be repeated here.

In some embodiments, the sixth indication information includes second indication information, and the second indication information is used to instruct the terminal device to report gap requirements for measuring the first MO in the respective cell states.

According to the embodiment, the network requests the terminal device to report the gap requirements of the terminal device for different cell states by transmitting the second indication information, in this way, it will facilitate the network to perform corresponding configuration.

Optionally, the second indication information includes an MO sequence, the second indication information is used to instruct the terminal device to report the gap requirements for measuring respective MOs in the MO sequence in the respective cell states, and the MO sequence includes a first MO.

Optionally, the second indication information includes first switch information, and the first switch information is used to indicate whether the terminal device is requested to report the gap requirements for measuring the first MO in the respective cell states.

Optionally, the first MO is an MO that meets a predetermined condition.

Optionally, the predetermined condition is that the first MO is related to a secondary cell.

The setting manner of the second indication information may refer to the corresponding description in the aforementioned embodiments, which will not be repeated here.

It should be noted that, the scheme of which the network device transmits the second indication information in the above embodiment may be independent of the scheme of which the network device transmits the third indication information in the aforementioned embodiments. Exemplarily, the network device requests the terminal device to report the gap requirements in different cell states, but the network device does not necessarily need to configure multiple gaps for different cell states to the terminal device. Exemplarily, the network device may perform relevant configuration for the terminal device according to the strictest gap requirement among the multiple gap requirements corresponding to multiple cell states. For example, in a case where the terminal device indicates that the gap is not required in the first state and the second state, the network device may consider configuring the terminal device to perform the measurement outside the gap. In this way, the problem that there is no out-of-gap measurement in the deactivated Scell in the related art may be overcome, so that the terminal device may measure the deactivated Scell outside the gap, and the interruption time of data transmission and reception will be further reduced.

It may be understood that, the scheme of which the network device transmits the second indication information in the above embodiment may also be combined with the scheme of which the network device transmits the third indication information in the aforementioned embodiments. For example, the network device transmits the second indication information to instruct the terminal device to report the gap requirements in different cell states, and after the terminal device transmits the first indication information to report the gap requirements, the network device transmits the third indication information to configure multiple gaps for the terminal device to measure the first MO in different cell states.

It can be seen that, the embodiments of the present disclosure provide the method for quickly updating the associated GAPs in response to the changes in the cell states, as well as the method for reporting the relevant capabilities/requirements of the UE. It is possible to achieve the measurement-related configuration for different cell states, improve the flexibility of measurement configuration, and further reduce the interruption time of data transmission caused by measuring.

FIG. 5 is a schematic block diagram of a terminal device 500 according to an embodiment of the present disclosure. The terminal device 500 may include:
a first communication module 510, configured to transmit first indication information to a network device; where the first indication information is used to indicate gap-related information in respective cell states of multiple cell states, where a gap includes a measurement gap (MG) and/or a network-controlled small gap (NCSG).

In an implementation, the first indication information is used to indicate gap requirements for measuring a first measurement object (MO) in the respective cell states.

In an implementation, the gap requirement is one of following: the MG being required, the NCSG being required, and the gap being not required.

In an implementation, the first indication information includes multiple gap requirement indications of the first MO, and the multiple gap requirement indications correspond one-to-one with the multiple cell states; where each gap requirement indication of the multiple gap requirement indications is used to indicate a gap requirement for measuring the first MO in a corresponding cell state.

In an implementation, the first indication information includes a gap requirement sequence of the first MO, and the gap requirement sequence includes gap requirements corresponding to the respective cell states.

In an implementation, the first indication information includes a target MO related indication, the target MO related indication is used to indicate gap requirement for measuring respective MOs in a target MO set in the respective cell states, and the target MO set includes the first MO.

In an implementation, the target MO related indication includes multiple gap requirement indications of the target MO set, and the multiple gap requirement indications correspond one-to-one with the multiple cell states; where each gap requirement indication of the multiple gap requirement indications is used to indicate gap requirements for measuring respective MOs in the target MO set in a corresponding cell state.

In an implementation, the target MO related indication includes a gap requirement sequence of the target MO set, and the gap requirement sequence includes gap requirements corresponding to the respective cell states.

In an implementation, the first communication module 510 is further configured to:
in a case where second indication information from the network device is received, transmit the first indication information to the network device.

In an implementation, the second indication information includes an MO sequence, and the second indication information is used to indicate reporting gap requirements for measuring respective MOs in the MO sequence in the respective cell states, and the MO sequence includes the first MO.

In an implementation, the second indication information includes first switch information, and the first switch information is used to indicate whether reporting the gap requirements for measuring the first MO in the respective cell states is requested.

In an implementation, the first MO is an MO that meets a predetermined condition.

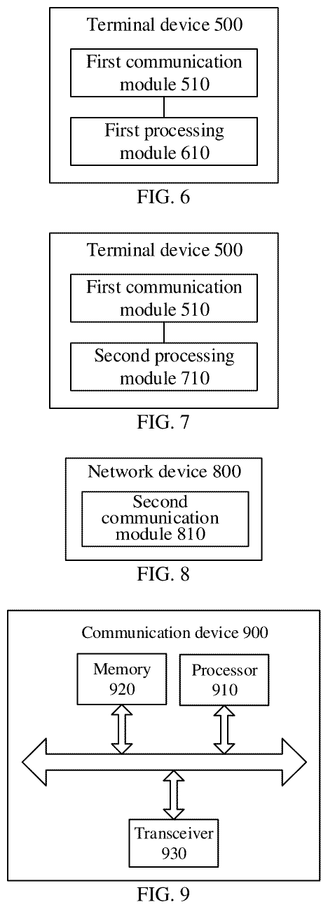

In an implementation, as illustrated in FIG. 6, the terminal device 500 further includes a first processing module 610, which is configured to:
determine that the first MO meets the predetermined condition according to configuration information of the first MO.

In an implementation, the predetermined condition is that the first MO is related to a secondary cell.

In an implementation, the first communication module 510 is further configured to:
receive third indication information from the network device; where the third indication information is used to indicate multiple gaps associated with a first MO, and the multiple gaps include gaps corresponding to the respective cell states of the multiple cell states.

In an implementation, as illustrated in FIG. 7, the terminal device 500 further includes a second processing module 710, which is configured to:
when switching cell states, determine a gap used for measuring the first MO according to the third indication information.

In an implementation, the third indication information is carried by configuration information of the first MO.

In an implementation, the third indication information includes multiple associated gap indications corresponding one-to-one with the multiple cell states, and each associated gap indication of the multiple associated gap indications is used to indicate an identifier of a gap used in a corresponding cell state.

In an implementation, the third indication information includes a gap identifier sequence, and the gap identifier sequence includes identifiers of respective gaps of the multiple measurement gaps.

In an implementation, the first communication module 510 is further configured to:
transmit fourth indication information to the network device, where the fourth indication information is used to indicate that a first capability is possessed, and the first capability includes supporting configuring the multiple gaps for the first MO.

In an implementation, the first communication module 510 is further configured to:
transmit fifth indication information to the network device, where the fifth indication information is used to indicate that a second capability is possessed, where the second capability includes supporting reporting gap requirements corresponding to the respective cell states.

In an implementation, the first communication module 510 is further configured to:
in a case where a first capability is possessed, transmit the fifth indication information to the network device; where the first capability includes supporting configuring multiple gaps for a first MO.

In an implementation, the fifth indication information is further used to indicate that a first capability is possessed, where the first capability includes supporting configuring multiple gaps for a first MO.

In an implementation, the multiple cell states include a cell state of a secondary cell.

In an implementation, the cell state of the secondary cell is determined based on whether the secondary cell is activated and/or whether the secondary cell is dormant.

The terminal device 500 in the embodiments of the present disclosure may implement the corresponding functions of the terminal device in the aforementioned method embodiments. The processes, functions, implementations and beneficial effects corresponding to various modules (sub-modules, units or components, etc.) in the terminal device 500 may be found in the corresponding description in the aforementioned method embodiments, which will not be repeated here. It should be noted that the functions described in the respective modules (sub-modules, units or components, etc.) in the terminal device 500 of the application embodiment may be implemented by different modules (sub-modules, units or components, etc.) or may be implemented by the same module (sub-module, unit or component, etc.).

FIG. 8 is a schematic block diagram of a network device 800 according to an embodiment of the present disclosure. The network device 800 may include:
a second communication module 810, configured to transmit sixth indication information to a terminal device, where the sixth indication information is used to indicate gap-related information in respective cell states of multiple cell states, where a gap includes an MG and/or an NCSG.

In an implementation, the sixth indication information includes third indication information, and the third indication information is used to indicate multiple gaps associated with a first MO, and the multiple gaps include gaps corresponding to the respective cell states of the multiple cell states.

In an implementation, the third indication information is carried by configuration information of the first MO.

In an implementation, the third indication information includes multiple associated gap indications corresponding one-to-one with the multiple cell states, and each associated gap indication of the multiple associated gap indications is used to indicate an identifier of a gap used in a corresponding cell state.

In an implementation, the third indication information includes a gap identifier sequence, the gap identifier sequence includes identifiers of respective gaps of the multiple gaps.

In an implementation, the second communication module 810 is further configured to:
receive fourth indication information from the terminal device, where the fourth indication information is used to indicate that the terminal device has a first capability, and the first capability includes supporting configuring multiple gaps for the first MO.

In an implementation, the second communication module 810 is further configured to:
receive fifth indication information from the terminal device, where the fifth indication information is used to indicate that the terminal device has s second capability, where the second capability includes supporting reporting gap requirements corresponding to the respective cell states.

In an implementation, the second communication module 810 is further configured to:
in a case where fourth indication information from the terminal device is received, receive the fifth indication information from the terminal device; where the fourth indication information is used to indicate that the terminal device has a first capability, and the first capability includes supporting configuring the multiple gaps for the first MO.

In an implementation, the fifth indication information is further used to indicate that the terminal device has a first capability, where the first capability includes supporting configuring the multiple gaps for the first MO.

In an implementation, the sixth indication information includes second indication information, and the second indication information is used to instruct the terminal device to report gap requirements for measuring the first MO in respective cell states.

In an implementation, the second indication information includes an MO sequence, the second indication information is used to instruct the terminal device to report gap requirements for measuring respective MOs in the MO sequence in the respective cell states, and the MO sequence includes the first MO.

In an implementation, the second indication information includes first switch information, and the first switch information is used to indicate whether the terminal device is requested to report the gap requirement for measuring the first MO in the respective cell states.

In an implementation, the first MO is an MO that meets a predetermined condition.

In an implementation, the predetermined condition is that the first MO is related to a secondary cell.

In an implementation, the second communication module 810 is further configured to:
receive first indication information from the terminal device; where the first indication information is used to indicate the gap requirements for measuring a first MO by the terminal device in the respective cell states.

In an implementation, a gap requirement is one of following: the MG being required, the NCSG being required, and the gap being not required.

In an implementation, the first indication information includes multiple gap requirement indications of the first MO, and the multiple gap requirement indications correspond one-to-one with the multiple cell states; where each gap requirement indication of the multiple gap requirement indications is used to indicate a gap requirement for measuring the first MO in a corresponding cell state.

In an implementation, the first indication information includes a gap requirement sequence of the first MO, and the gap requirement sequence includes gap requirements corresponding to the respective cell states.

In an implementation, the first indication information includes a target MO related indication, the target MO related indication is used to indicate gap requirements for measuring respective MOs in a target MO set in the respective cell states, and the target MO set includes the first MO.

In an implementation, the target MO related indication includes multiple gap requirement indications of the target MO set, and the multiple gap requirement indications correspond one-to-one with the multiple cell states; where each gap requirement indication of the multiple gap requirement indications is used to indicate gap requirement for measuring respective MOs in the target MO set in a corresponding cell state.

In an implementation, the target MO related indication includes a gap requirement sequence of the target MO set, and the gap requirement sequence includes the gap requirements corresponding to the respective cell states.

In an implementation, the multiple cell states include a cell state of a secondary cell.

In an implementation, the cell state of the secondary cell is determined based on whether the secondary cell is activated and/or whether the secondary cell is dormant.

The network device 800 in the embodiments of the present disclosure may implement the corresponding functions of the network device in the aforementioned method embodiments. The processes, functions, implementations and beneficial effects corresponding to various modules (sub-modules, units or components, etc.) in the network device 800 may be found in the corresponding description in the above method embodiments, which will not be repeated here. It should be noted that the functions described in the respective modules (sub-modules, units or components, etc.) in the network device 800 of the embodiment of the present disclosure may be implemented by different modules (sub-modules, units or components, etc.), or may be implemented by the same module (sub-module, unit or component, etc.).

FIG. 9 is a schematic structural diagram of a communication device 900 according to the embodiments of the present disclosure. The communication device 900 includes a processor 910, which may call the computer program from a memory and run the computer program, to cause the communication device 900 to implement the methods in the embodiments of the present disclosure.

In an implementation, the communication device 900 may further include a memory 920. The processor 910 may call the computer program from the memory 920 and run the computer program, to cause the communication device 900 implements the methods in the embodiments of the present disclosure.

The memory 920 may be a separate device independent of the processor 910, or may be integrated into the processor 910.

In an implementation, the communication device 900 may further include a transceiver 930, and the processor 910 may control the transceiver 930 to communicate with other devices, specifically, may transmit information or data to other devices, or receive information or data transmitted by other devices.

The transceiver 930 may include a transmitter and a receiver. The transceiver 930 may further include an antenna, and the number of the antenna may be one or more.

In an implementation, the communication device 900 may be the terminal device in the embodiments of the present disclosure, and the communication device 900 may implement the corresponding processes implemented by the terminal device in various methods in the embodiments of the present disclosure, which will not be repeated in detail herein for brevity.

In an implementation, the communication device 900 may be a network device in the embodiments of the present disclosure, and the communication device 900 may implement the corresponding processes implemented by the network device in various methods in the embodiments of the present disclosure, which will not be repeated in detail herein for brevity.

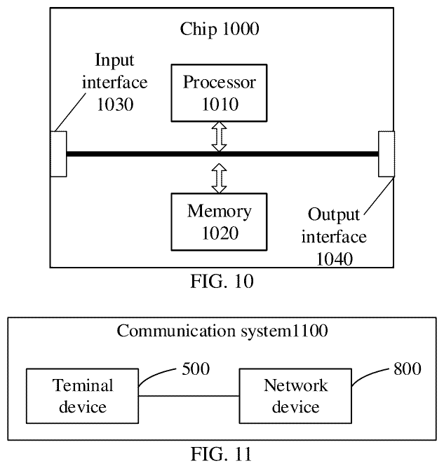

FIG. 10 is a schematic structural diagram of a chip 1000 according to the embodiments of the present disclosure. The chip 1000 includes a processor 1010, which may call the computer program from a memory and run the computer program, to implement the methods in the embodiments of the present disclosure.

In an implementation, the chip 1000 may further include a memory 1020. The processor 1010 may call the computer program from the memory 1020 and run the computer program, to implement the methods executed by the terminal device in the embodiments of the present disclosure.

The memory 1020 may be a separate device independent of the processor 1010, or may be integrated into the processor 1010.

In an implementation, the chip 1000 may further include an input interface 1030. The processor 1010 may control the input interface 1030 to communicate with other devices or chips, and specifically, may control the input interface 1030 to obtain information or data transmitted by other devices or chips.

In an implementation, the chip 1000 may further include an output interface 1040. The processor 1010 may control the output interface 1040 to communicate with other devices or chips, and specifically, may control the input interface 1030 to output information or data to other devices or chips.

In an implementation, the chip may be applied to the terminal device in the embodiments of the present disclosure, and the chip may implement the corresponding processes implemented by the terminal device in the various methods in the embodiments of the present disclosure, which will not be repeated herein for brevity.

In an implementation, the chip may be applied to the network device in the embodiments of the present disclosure, and the chip may implement the corresponding processes implemented by the network device in various methods in the embodiments of the present disclosure, which will not be repeated herein for brevity.

It should be understood that, the chip mentioned in the embodiments of the present disclosure may also be called a system-level chip, a system chip, a chip system or a system-on-chip, etc.

The processor mentioned above may be a general purpose processor, a digital signal processor (DSP), a field programmable gate array (FPGA), an application specific integrated circuit (ASIC) or other programmable logic devices, transistor logic devices, discrete hardware components, etc. The general purpose processor may be a microprocessor or any conventional processor.

The memory mentioned above may be a volatile (transitory) memory or a non-volatile (non-transitory) memory, or may include both volatile and non-volatile memories. The non-volatile memory may be a read-only memory (ROM), a programmable ROM (PROM), an erasable programmable read-only memory (erasable PROM, EPROM), an electrically erasable programmable read-only memory (electrically EPROM, EEPROM), or a flash. The volatile memory may be a random access memory (RAM).

It should be understood that, the memories mentioned above are exemplary but not limited. For example, in the embodiments of the present disclosure, the memory may further be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM) and a direct memory bus random access memory (Direct Rambus RAM, DR RAM). That is, the memory in the embodiments of the present disclosure is intended to include but is not limited to these and any other suitable types of memories.

FIG. 11 is a schematic block diagram of a communication system 1100 according to the embodiments of the present disclosure. The communication system 1100 includes the terminal device 500 and the network device 800.

Optionally, the terminal device 500 may be configured to transmit first indication information to the network device 800; where the first indication information is used to indicate gap-related information in respective cell states of multiple of cell states.

Optionally, the network device 800 may be configured to transmit sixth indication information to the terminal device 500, where the sixth indication information is used to indicate gap-related information in respective cell states of multiple cell states.

In the above embodiments, all or part of them may be implemented by software, hardware, firmware or any combination thereof. When implemented using software, all or part of the implementation may be in the form of the computer program product. The computer program product includes one or more computer instructions. When the computer program instructions are loaded and executed on a computer, the process or function described in the embodiments of the present disclosure is generated in whole or in part. The computer may be a general purpose computer, a special purpose computer, a computer network, or other programmable apparatus. The computer instructions may be stored in the non-transitory computer-readable storage medium, or may be transmitted from one non-transitory computer-readable storage medium to another non-transitory computer-readable storage medium. For example, the computer instructions may be transmitted from one website, computer, server, or data center to another website, computer, server, or data center via a wired means (e.g., coaxial cable, optical fiber, digital subscriber line (DSL)) or a wireless means (e.g., infrared, wireless, microwave, etc.). The non-transitory computer-readable storage medium may be any available medium that may be accessed by a computer, or may be a data storage device such as a server or a data center that includes one or more available media. The available medium may be a magnetic medium (e.g., a floppy disk, a hard disk, a magnetic tape), an optical medium (e.g., a DVD), or a semiconductor medium (e.g., a solid state disk (SSD)).

It should be understood that, in the various embodiments of the present disclosure, the magnitude of the serial numbers of the above-mentioned processes does not mean the order of execution. The execution order of each process should be determined by its function and internal logic, and should not constitute any limitation on the implementation process of the embodiments of the present disclosure.

It may be clearly understood by those skilled in the art that, for convenience and brevity of the description, the specific working processes of the system, apparatus and unit described above may refer to the corresponding procedures in the aforementioned method embodiments, which will not be repeated here.

The foregoing descriptions are merely specific implementations of the present disclosure, but the protection scope of the present disclosure is not limited thereto. Any person skilled in the art may readily conceive variations or substitutions within the technical scope disclosed in the present disclosure, which should be included within the protection scope of the present disclosure. Therefore, the protection scope of the present disclosure shall be subject to the protection scope of the claims.

What is claimed is:

1. A terminal device, comprising: a processor and a memory, wherein the memory is configured to store a computer program, and the processor is configured to call the computer program stored in the memory and run the computer program, to cause the terminal device to perform:
transmitting first indication information to a network device; wherein the first indication information is used to indicate gap-related information in respective cell states of multiple cell states, wherein a gap comprises a measurement gap (MG) and/or a network controlled small gap (NCSG).

2. The terminal device according to claim 1, wherein the first indication information is used to indicate gap requirements for measuring a first measurement object (MO) by the terminal device in the respective cell states; and a gap requirement is one of following: the MG being required, the NCSG being required, and the gap being not required.

3. The terminal device according to claim 2, wherein the first indication information comprises multiple gap requirement indications of the first MO, and the multiple gap requirement indications correspond one-to-one with the multiple cell states; wherein each gap requirement indication of the multiple gap requirement indications is used to indicate a gap requirement for measuring the first MO in a corresponding cell state; or
the first indication information comprises a gap requirement sequence of the first MO, and the gap requirement sequence comprises gap requirements corresponding to the respective cell states; or
the first indication information comprises a target MO related indication, the target MO related indication is used to indicate gap requirements for measuring respective MOs in a target MO set in the respective cell states, and the target MO set comprises the first MO.

4. The terminal device according to claim 3, wherein the target MO related indication comprises multiple gap requirement indications of the target MO set, and the multiple gap requirement indications correspond one-to-one with the multiple cell states; wherein each gap requirement indication of the multiple gap requirement indications is used to indicate gap requirements for measuring respective MOs in the target MO set in a corresponding cell state; or
the target MO related indication comprises a gap requirement sequence of the target MO set, and the gap requirement sequence comprises gap requirements corresponding to the respective cell states.

5. The terminal device according to claim 2, wherein the processor is configured to call the computer program stored in the memory and run the computer program, to cause the terminal device to further perform:
in a case where second indication information from the network device is received, transmitting the first indication information to the network device; wherein the second indication information is used to instruct the terminal device to report gap requirements corresponding to the respective cell states of the multiple cell states.

6. The terminal device according to claim 5, wherein the second indication information comprises an MO sequence, and the second indication information is used to instruct the terminal device to report gap requirements for measuring respective MOs in the MO sequence in the respective cell states, and the MO sequence comprises the first MO; or
the second indication information comprises first switch information, and the first switch information is used to indicate whether the terminal device is requested to report the gap requirements for measuring the first MO in the respective cell states.

7. The terminal device according to claim 1, wherein the processor is configured to call the computer program stored in the memory and run the computer program, to enable the terminal device to further to perform:
receiving third indication information from the network device; wherein the third indication information is used to indicate multiple gaps associated with a first MO, and the multiple gaps comprise gaps corresponding to the respective cell states of the multiple cell states.

8. The terminal device according to claim 7, wherein the processor is configured to call the computer program stored in the memory and run the computer program, to enable the terminal device to further perform:
when switching cell states, determining a gap used for measuring the first MO according to the third indication information;
wherein the third indication information is carried by configuration information of the first MO.

9. The terminal device according to claim 7, wherein the third indication information comprises multiple associated gap indications corresponding one-to-one with the multiple cell states, and each associated gap indication of the multiple associated gap indications is used to indicate an identifier of a gap used in a corresponding cell state; or
the third indication information comprises a gap identifier sequence, and the gap identifier sequence comprises identifiers of respective gaps of the multiple gaps.

10. The terminal device according to claim 7, wherein before receiving the third indication information from the network device, the processor is configured to call the computer program stored in the memory and run the computer program, to cause the terminal device further to perform:
transmitting fourth indication information to the network device, wherein the fourth indication information is used to indicate that the terminal device has a first capability, and the first capability comprises supporting configuring the multiple gaps for the first MO.

11. The terminal device according to claim 1, wherein before transmitting the first indication information to the network device, the processor is configured to call the computer program stored in the memory and run the computer program, to cause the terminal device further to perform:
in a case where the terminal device has a first capability, transmitting fifth indication information to the network device, wherein the first capability comprises supporting configuring multiple gaps for a first MO.

12. The terminal device according to claim 11, wherein the fifth indication information is used to indicate that the terminal device has a second capability, and the second capability comprises supporting reporting gap requirements corresponding to the respective cell states; and/or
wherein the fifth indication information is further used to indicate that the terminal device has the first capability, and the first capability comprises supporting configuring multiple gaps for a first MO.

13. The terminal device according to claim 1, wherein the multiple cell states comprise a cell state of a secondary cell; and the cell state of the secondary cell is determined based on whether the secondary cell is activated and/or whether the secondary cell is dormant.

14. A network device, comprising: a processor and a memory, wherein the memory is configured to store a computer program, and the processor is configured to call the computer program stored in the memory and run the computer program, to cause the network device to perform:
receiving first indication information from a terminal device; wherein the first indication information is used to indicate gap-related information in respective cell states of multiple cell states, wherein a gap comprises a measurement gap (MG) and/or a network controlled small gap (NCSG).

15. The network device according to claim 14, wherein the first indication information is used to indicate gap requirements for measuring a first measurement object (MO) by the terminal device in the respective cell states; and a gap requirement is one of following: the MG being required, the NCSG being required, and the gap being not required.

16. The network device according to claim 15, wherein the first indication information comprises multiple gap requirement indications of the first MO, and the multiple gap requirement indications correspond one-to-one with the multiple cell states; wherein each gap requirement indication of the multiple gap requirement indications is used to indicate a gap requirement for measuring the first MO in a corresponding cell state; or
the first indication information comprises a gap requirement sequence of the first MO, and the gap requirement sequence comprises gap requirements corresponding to the respective cell states; or
the first indication information comprises a target MO related indication, the target MO related indication is used to indicate gap requirements for measuring respective MOs in a target MO set in the respective cell states, and the target MO set comprises the first MO.

17. The network device according to claim 16, wherein the target MO related indication comprises multiple gap requirement indications of the target MO set, and the multiple gap requirement indications correspond one-to-one with the multiple cell states; wherein each gap requirement indication of the multiple gap requirement indications is used to indicate gap requirements for measuring respective MOs in the target MO set in a corresponding cell state; or
the target MO related indication comprises a gap requirement sequence of the target MO set, and the gap requirement sequence comprises gap requirements corresponding to the respective cell states.

18. The network device according to claim 15, wherein the processor is configured to call the computer program stored in the memory and run the computer program, to enable the network device to further to perform:
transmitting second indication information to the terminal device, wherein the second indication information is used to instruct the terminal device to report gap requirements corresponding to the respective cell states of the multiple cell states; and
receiving the first indication information from the network device.

19. The network device according to claim 14, wherein the processor is configured to call the computer program stored in the memory and run the computer program, to enable the network device to further to perform:
transmitting sixth indication information to a terminal device, wherein the sixth indication information is used to indicate gap-related information in respective cell states of multiple cell states, wherein a gap comprises an MG and/or an NCSG;
wherein the sixth indication information comprises third indication information, and the third indication information is used to indicate multiple gaps associated with a first MO, and the multiple gaps comprise gaps corresponding to the respective cell states of the multiple cell states.

20. The network device according to claim 19, the processor is configured to call the computer program stored in the memory and run the computer program, to cause the network device further to perform:
receiving fourth indication information from the terminal device, wherein the fourth indication information is used to indicate that the terminal device has a first capability, and the first capability comprises supporting configuring the multiple gaps for the first MO; or
receiving fifth indication information from the terminal device, wherein the fifth indication information is used to indicate that the terminal device has a second capability, wherein the second capability comprises supporting reporting gap requirements corresponding to the respective cell states.
